(19) United States
(12) Patent Application Publication
(10) Pub. No.: US 2019/0251504 A1
(43) Pub. Date: Aug. 15, 2019

(54) TRANSPORTATION NETWORK FOR CONTINUOUS MOVEMENT OF CARGO

(71) Applicant: Jeremy Spillman, Ankeny, IA (US)

(72) Inventor: Jeremy Spillman, Ankeny, IA (US)

(21) Appl. No.: 16/275,150

(22) Filed: Feb. 13, 2019

Related U.S. Application Data
(60) Provisional application No. 62/630,645, filed on Feb. 14, 2018.

(51) Int. Cl. G06Q 10/08; G06Q 20/10

(52) U.S. Cl. CPC G06Q 10/0834; G06Q 10/0833; G06F 16/23; G06Q 10/0838; G06Q 20/10

(57) ABSTRACT

An over the road full service transportation network provides short haul and/or final delivery services for a variety of supply chain networks via an interconnected web of secure transfer sites resulting in an ongoing delivery network with zero downtime. The transportation network includes at least a network-owned trailer infrastructure as well as the land sites and trailer terminals. The transportation network also includes final mile delivery vehicles at every terminal to enable final mile delivery needs. Immediate payment upon completion of delivery is accomplished using a blockchain payment system of the transportation system.

### CROSS REFERENCE TO RELATED APPLICATION

This application claims priority under 35 U.S.C. § 119 to provisional application Ser. No. 62/630,645 filed Feb. 14, 2018, which is hereby incorporated by reference in its entirety.

### FIELD OF THE DISCLOSURE

The present disclosure relates to the transportation of cargo. More particularly, but not exclusively, the present disclosure relates to a transportation network, method and system for continuous movement of cargo through trailer terminal sites and final delivery to a destination with immediate driver payment for completed routes.

### BACKGROUND

Independent contractor models are driven and managed by multiple resources and industries creating a convoluted structure and misappropriated amount of time and energy to accomplish the ultimate task of cargo delivery. Currently, long haul loads are generated by one of two ways, either by manufactures/shippers (i.e., “brokerage model”) or regional/national trucking companies. Each provide a service that have a very high time or attenuated time in transit from pickup to delivery. Manufactures/shippers (i.e., “brokerage model”) also have a problem with trying to maximize capacity within the trailers themselves and, often to boost margins, cargo that was expected to be riding alone within a single trailer may be transported with other cargo outside of the shipper's knowledge. This scenario also has a large impact on the amount of damaged cargo further driving up costs. An even larger problem within the brokerage model is the type of payment transaction used for paying drivers. Many brokers will not pay the driver for 30-60 days, sometimes even longer, after completion of a delivery/shipping contract. This in turn requires factoring companies to step in and buy the shipping contract, pay the driver after taking a percentage of the contract so the driver can be paid in a timely fashion. Ultimately, however, the driver loses a portion of the dollar value of the shipping contract in order to get paid sooner.

Therefore, what is needed is a transportation network, method and system for continuous movement of cargo that address the deficiencies in the transportation of cargo and payment of cargo carriers.

Therefore, there is a need for a transportation network, method and system for continuous movement of cargo via short hauls while issuing prompt payments to drivers using an integrated blockchain technology thereby addressing the delay in payment by initiating immediate payment to drivers.

Another deficiency of the current approaches to transporting cargo is the driver knowledge that is necessary, but is often absent or lacking, to provide seamless and speedy transition from pickup to delivery. Although the regional/national trucking companies can curtail some of the local knowledge when delivery is made, the independent owner/operators often will not have the local area knowledge to provide a seamless delivery.

Therefore, there is a need for a transportation network, method and system for continuous movement of cargo that addresses problems in the art by keeping the independent contractors on the interstate systems only and having local employees providing final mile delivery of cargo.

With current shipping practices contract drivers, acting as long haul drivers, move cargo loads across long distances of a geographical region. This practice is fraught with issues, most of which decrease the efficiency of shipping, impede best practices for resource allocation, and misappropriate driver/driving time (e.g., “wheels-in-motion”) management.

Therefore, there is a need for a transportation network, method and system for continuous movement of cargo from origination, transportation to final destination that replaces traditional long haul routes with short haul routes between a network of geographically spaced trailer terminals.

### SUMMARY

Therefore, it is a primary object, feature, or advantage of the present disclosure to improve over the state of the art.

It is a further object, feature, or advantage of the present disclosure to provide a method for continuous movement of cargo through trailer terminal sites and final delivery to a destination with immediate driver payment for completed routes.

It is a still further object, feature, or advantage of the present disclosure to provide a service transportation network operating a network of trailer terminals spaced apart geographically for receiving, staging and/or delivering a cargo load transported by a driver.

Another object, feature, or advantage of the present disclosure is to provide one or more smart contracts and executing payment of the short haul drivers and employees of the service transportation network with a blockchain system.

Yet another object, feature, or advantage of the present disclosure is to provide a driver operating as an independent contractor who enters into an agreement with the service transportation network as a short haul driver for each cargo load, or the driver is a final leg driver and an employee of the service transportation network for each cargo load.

According to at least one aspect of the disclosure, a method for continuous movement of cargo through trailer terminal sites and final delivery to a destination with immediate driver payment for completed routes is disclosed. The method includes, for example, providing a service transportation network operating a network of trailer terminals spaced apart geographically for receiving, staging and/or delivering a cargo load transported by a driver, wherein the driver operating as an independent contractor enters into an agreement with the service transportation network as a short haul driver for each cargo load, or the driver is a final leg driver and an employee of the service transportation network for each cargo load. A payment contract is created for the cargo load between a shipper, manufacturer, import location, or consignees and the service transportation network based at least on an origin of the cargo load and a delivery location of the cargo load. The independent contractor driver selects a cargo load from a number of cargo loads at one of the trailer terminals from one of the network of trailer terminals, wherein the cargo load has a delivery schedule with one or more legs between an origination trailer terminal and a destination trailer terminal. The cargo load is received at a final destination trailer terminal, wherein the cargo load is delivered to a final destination by the final leg driver. Each cargo load location is monitored electronically, and a database associated with the service transportation network is updated. Payment to the short haul drivers is executed upon completion of each leg by issuing payment using a payment system.

One or more of these and/or other objects, features, or advantages of the present disclosure will become apparent from the specification and claims that follow. No single aspect need provide each and every object, feature, or advantage. Different aspects may have different objects, features, or advantages. Therefore, the present disclosure is not to be limited to or by an objects, features, or advantages stated herein.

### BRIEF DESCRIPTION OF THE DRAWINGS

Illustrated aspects of the present disclosure are described in detail below with reference to the attached drawing figures, which are incorporated by reference herein, and where:

FIG. 1 is a pictorial representation of a known transportation network system in accordance with an illustrative aspect of the present disclosure;

FIG. 2 is a pictorial representation of the projected average daily long-haul truck traffic on the national highway system for the year 2035 in accordance with an illustrative aspect of the present disclosure;

FIG. 3 is a pictorial representation of a transportation network for continuous movement of cargo in accordance with an illustrative aspect of the present disclosure;

FIG. 4 is a pictorial illustration of a transportation network diagram for continuous movement of cargo in accordance with an illustrative aspect of the present disclosure;

FIG. 5 is a pictorial representation of a transportation network and personnel contract fulfillment system for continuous movement of cargo in accordance with an illustrative aspect of the present disclosure;

FIG. 6 is a pictorial representation of another transportation network and payment fulfillment system diagram system for continuous movement of cargo in accordance with an illustrative aspect of the present disclosure; and

FIG. 7 is a pictorial representation of a transportation network and logistics control system for continuous movement of cargo in accordance with another illustrative aspect of the present disclosure.

### DETAILED DESCRIPTION

The present disclosure contemplates many different methods and systems for continuous movement of cargo through trailer terminal sites and final delivery to a destination with immediate driver payment for completed routes. The present disclosure also contemplates methods and systems for continuous movement of cargo and payments to drivers using an integrated blockchain technology that addresses the delay in payment by initiating immediate payment to drivers. Representative applications and methods and systems according to the present application are described in this section. These examples are being provided solely to provide context and aid in understanding of the several described aspects. It will thus be apparent to one skilled in the art that the described aspects may be practiced without some and/or all of these specific details. In other instances, well known process steps have not been described in detail in order to avoid unnecessarily obscuring the described aspects. Other applications are possible, such that the following examples should not be taken as limiting.

In the following detailed description, references are made to the accompanying drawings, which form a part of the description and show, by way of illustration, specific aspects in accordance with the methods, systems and structures of the present disclosure. Although these aspects are described in sufficient detail to enable one skilled in the art to practice the described aspects, it is understood that these examples are not limiting; other aspects may be used, and changes may be made without departing from the spirit and scope of the described aspects.

It will also be understood that, although the terms first, second, etc. may be used herein to describe various elements, these elements should not be limited by such terms. These terms are only used to distinguish one element from another. For example, a first step could be termed a second step, and, similarly, a second step could be termed a first step, without departing from the spirit and scope of the present disclosure.

The terminology used herein is for the purpose of describing particular aspects only and is not intended to be limiting of the present disclosure. As used in the description of the disclosure and the appended claims, the singular forms “a”, “an” and “the” are intended to include the plural forms as well, unless the context clearly indicates otherwise. By way of example only, while the singular form of numerous components and steps are described in various aspects herein, it will be apparent that more than one of such components and/or steps can be used to accomplish the same. It will also be understood that the term “and/or” as used herein refers to and encompasses any and all possible combinations of one or more of the associated listed items. It will be further understood that the terms “comprises” and/or “comprising,” when used in this specification, specify the presence of stated features, functions, integers, steps, operations, elements, and/or components, but do not preclude the presence and/or addition of one or more other features, integers, steps, operations, elements, components, and/or groups thereof. It will be similarly understood that the terms “including,” “include,” “includes”, “such as” and the like, when used in this specification, are intended to be exemplary and should be construed as including, but not be limited to, all items recited thereafter. As used herein, the term “if” may be construed to mean “when” or “upon” or “in response to determining” or “in response to detecting,” depending on the context.

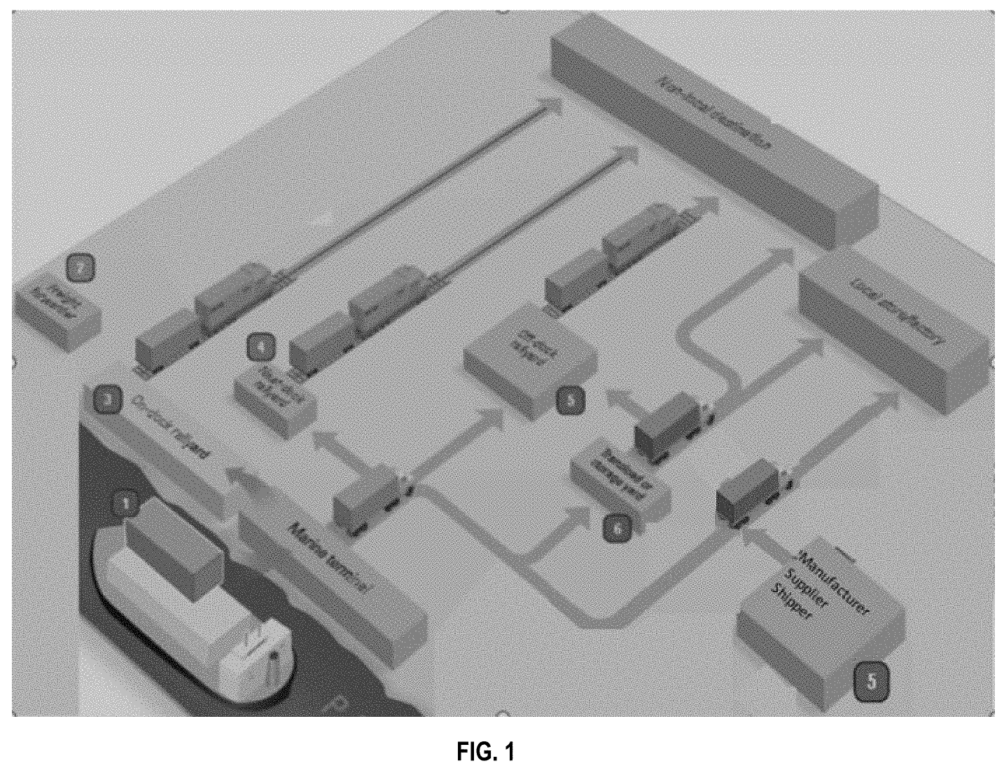

With reference to the drawings, FIG. 1 is a pictorial representation of a known transportation network system in accordance with an illustrative aspect of the present disclosure, such as one currently in practice for moving a cargo load from an origin to a destination. For example, payments to drivers are often made months after delivery of the cargo load under the current practices and methods. Sometimes payment can be made somewhat contemporaneously with delivery of a cargo load by engaging a 3rd party broker or factoring company. Unfortunately, use of a 3^{rd} party broker or factoring company cuts into the payment amount made to a driver. Delivery of cargo under the current paradigms typically involve a long haul driver or short haul driver transporting cargo from an origin to a final delivery destination. Often transportation under the current paradigms involve the use of independent contractor models driven and managed by multiple resources and industries creating a convoluted structure and misappropriated amount of time and energy to accomplish the ultimate task of cargo delivery. For example, currently long haul loads are transported by one of two models, either by the brokerage model or employee based carriers. In a brokerage model, the broker matches shippers with carriers on a as needed basis. In an employee based carrier model, there are typically predetermined lanes in which shippers have contracted regular work with these companies creating a more definitive schedule and regular runs that can be staffed to accommodate those shipment needs. The latter is typically a higher cost service due to the regularity and clarity needed to perform at a higher frequency and ensure loads are picked up and delivered as predetermined by the contracts previously negotiated. Each provide a service that have a very high time in transit from pickup to delivery. The brokerage model also has a problem with trying to maximize capacity within the trailers themselves and, often to boost margins, product that was expected to be riding alone within a single trailer may be combined with other products outside of the shipper's knowledge. The exemplary scenario shown in FIG. 1 can have a large impact on the frequency of damaged cargo, thereby further driving up unintended costs. An even larger problem within the brokerage model is the type of payment transaction used for paying drivers. Many brokers will not pay the driver for 30-60 days, sometimes even longer, until after the completion of a delivery/shipping contract. To obviate the lag in payment, factoring companies are used. Factoring companies buy the shipping contract and pay the driver after taking a percentage of the contract so the driver can be paid in timely fashion. Ultimately, however, as indicated, the driver loses a portion of the dollar value of the shipping contract in order to get paid earlier. Other issues also are important to consider under the current cargo delivery methods illustrated in FIG. 1. For example, long haul drivers often lack the necessary local delivery knowledge to help improve delivery efficiency to the final delivery destination. Also, with current shipping practices, contract drivers act as long haul drivers, moving cargo loads across long distances of a geographical region. This practice is fraught with issues, that amongst other things, decreases the efficiency of shipping, impedes best practices for allocation of shipping resources, and misappropriates driver/driving time (e.g., “wheels-in-motion”) management.

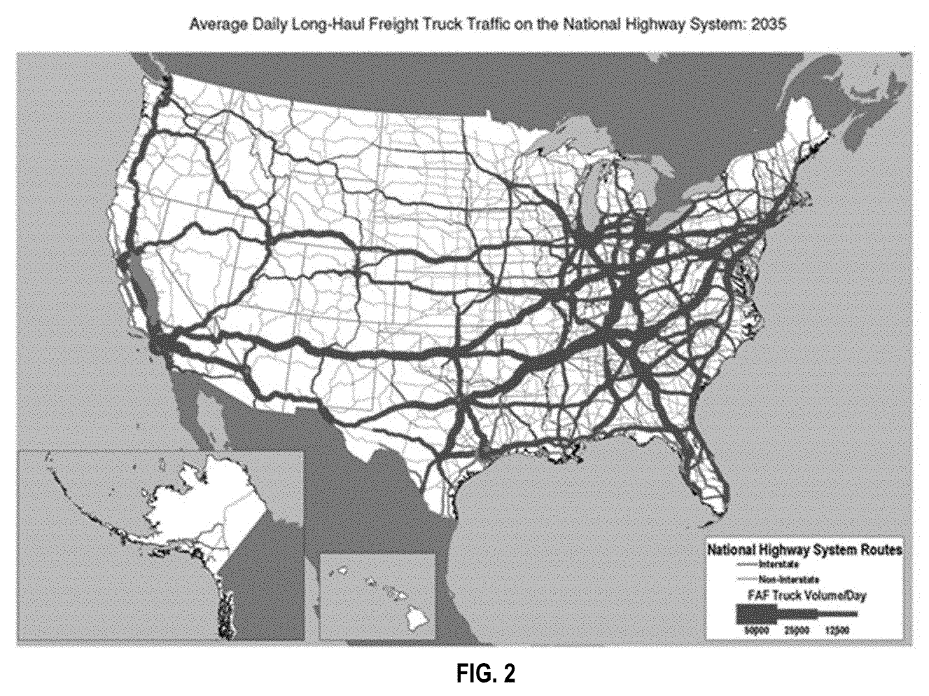

FIG. 2 provides a pictorial illustration showing that the long-haul truck traffic between places at least 50 miles apart is expected to increase dramatically on interstate highways and other arterials throughout the nation by the year 2035. Forecast data indicates that truck travel may reach 600 million miles per day. Given the large increase in long haul truck traffic to occur in the coming years and the associated issues with long hauls of cargo loads, the issues identified herein are sure to only increase and become even more problematic, thereby cutting into delivery efficiencies and profit, while increasing the amount of damaged or unrepairable cargo.

Therefore, there is a need for different methods and systems for continuous movement of cargo through trailer terminal sites and final delivery to a destination with immediate driver payment for completed routes that can address the associated problems with the future increase in cargo delivery. Furthermore, there is a need for a transportation network, method and system for continuous movement of cargo from origination, transportation to final destination that replaces traditional long haul routes with short haul routes between a network of geographically spaced trailer terminals. In view of the foregoing it's also imperative to provide methods and systems for continuous movement of cargo and payments to drivers using an integrated blockchain technology that addresses the delay in payment by initiating immediate payment to drivers upon route completion to encourage growth in the supply of drivers and address the speed at which cargo will need to move and payment to a drive to occur for a delivery.

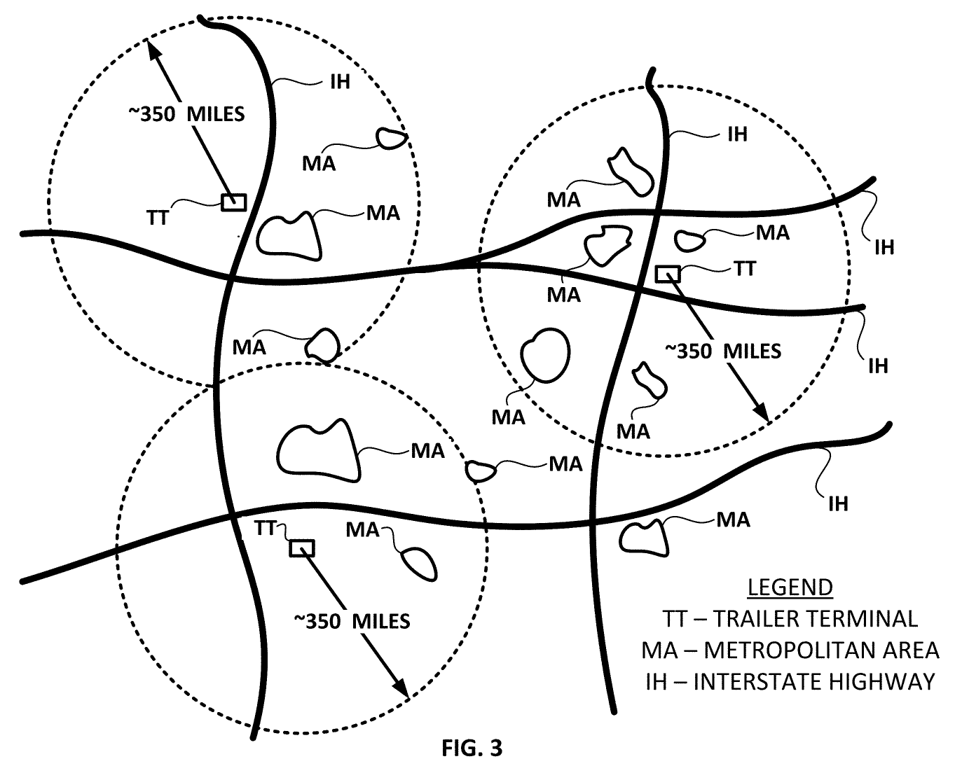

FIGS. 3-7 disclose various aspects of the present disclosure. FIG. 3 provides a pictorial representation of a geographical region with trailer locations setup to receive, store and deliver a cargo load between trailer terminals (“TT”), from a cargo origin, and/or to a final delivery destination. Trailer terminal locations are set up all across a geographical region (e.g., United States) and located within 350 miles from each other so as to produce no longer than an 11 hour drive to and from each site. This will allow for 24 hour or less of a drive based on to and from (i.e., roundtrip) hours of service that do not exceed an 11 hour day behind the wheel (*calculations are based off of 65 mph roadways) for the driver. Preferably, each trailer terminal would be located in proximity to an interstate highway (“IH”). Also, one or more metropolitan areas (“MA”) are contained within a 350 mile range of each trailer terminal. The strategic location of each trailer terminal will improve driver flexibility on what would traditionally be a long haul route, and as well as short haul runs to allow for selective route patterns conducive to driver knowledge and preference and to also allow a driver to run shorter patterns so as to be closer to their origin/home at all times, if preferred, so they have the option to be back home as dictated by their travel selections.

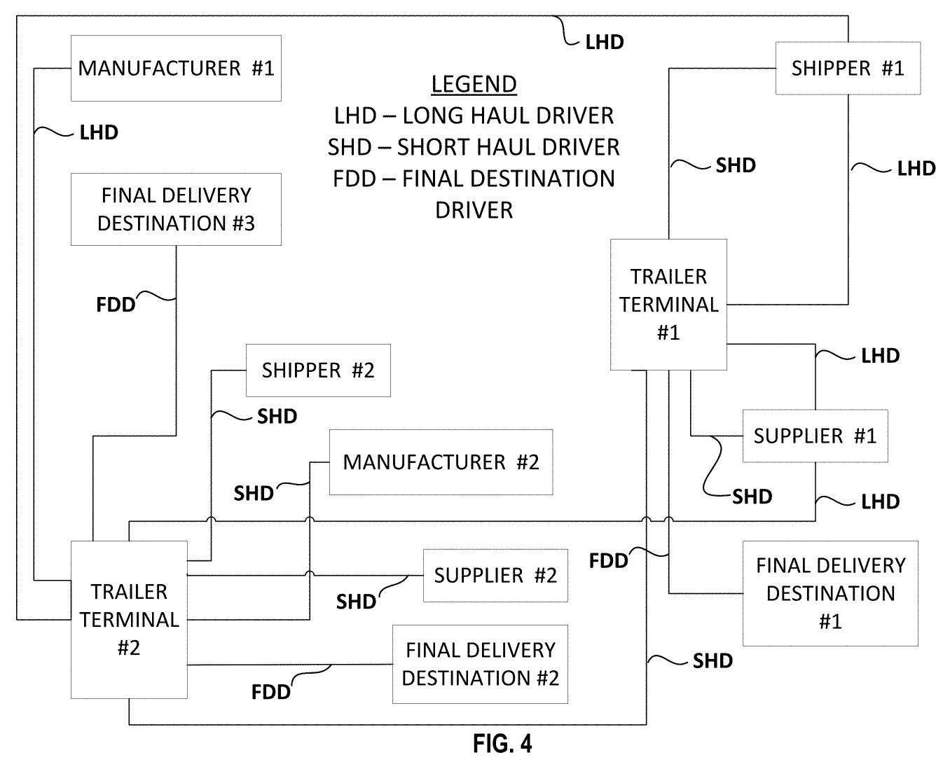

FIG. 4 is a pictorial illustration of a transportation network diagram for continuous movement of cargo in accordance with another illustrative aspect of the present disclosure. As shown, the system/network includes one or more trailer terminals strategically located within a geographical region. For purposes of illustration, trailer terminals #1 and #2 are shown. Any number of geographically spaced trailer terminals can be used. For discussion and clarification, trailer terminal #1 stores, receives and delivers cargo loads akin to trailer terminal #2. Cargo loads can be received at trailer terminal #1 from a supplier, shipper, consignee, and/or manufacturer via an initial pickup driver (“IPD”) (e.g., employee of the transportation system) and/or final destination driver (“FDD”) (e.g., employee of the transportation system) based on at least the following factors, such as proximity of the supplier, shipper, consignee and/or manufacturer. Other factors can include route location, route time, cargo load type, next route options, destination of cargo, capacity of trailer, etc. One or more cargo loads can be delivered from trailer terminal #1 or trailer terminal #2 to a final delivery destination (“FDD”) by a final destination driver (“FDD”) (e.g., employee of the transportation system). In another aspect, one or more cargo loads can be delivered from other trailer terminals to a final delivery destination (“FDD”) by a final destination driver (“FDD”) (e.g., employee of the transportation system). Additionally, one or more cargo loads can be moved between trailer terminals (e.g., trailer terminal #1 and trailer terminal #2) by a short haul driver (“SHD”) (e.g., contractor of the transportation system). Preferably, cargo loads are moved between trailer terminals by short haul drivers who are independent contractors of the transportation system. In another aspect, and for purposes of illustration, trailer terminal #2 stores, receives and delivers cargo loads akin to trailer terminal #1. Cargo loads can also be received at trailer terminal #2 from a supplier, shipper, consignee, and/or manufacturer via an initial pickup driver (“IPD”) (e.g., employee of the transportation system) and/or final destination driver (“FDD”) (e.g., employee of the transportation system) based on the closer proximity of the supplier, shipper, consignee, and/or manufacturer. One or more cargo loads can be delivered from trailer terminal #2 to one or more final delivery destinations (“FDD”) (e.g., final delivery destination #2 and final delivery destination #3) by a final destination driver (“FDD”) (e.g., employee of the transportation system). Similarly, cargo delivery loads can be received at the trailer terminal #2 or another trailer terminal in the network of trailer terminals from a supplier, shipper, consignee, and/or manufacturer via an initial pickup driver (“IPD”) (e.g., employee of the transportation system) and/or final destination driver (“FDD”) (e.g., employee of the transportation system). Therefore, cargo loads can be received, stored and delivered to and between trailer terminals, and to final delivery destinations, from suppliers, shippers, consignees and/or manufacturers. Under the methods and systems for cargo movement and driver payment of the current disclosure, trailers are continuously moving through the network via short haul independent contractors. In a preferred aspect, independent contractors would not be asked to perform final delivery destination to keep their limited (final delivery) knowledge base on the highway/interstate system where trailer terminal sites will be strategically located within immediate access to the interstate system. In addition, employees of the transportation system (network) of the present disclosure will provide delivery to a final delivery destination (within 250 miles give or take based on a geographic region). Beneficially, any local knowledge base of the employees will help improve efficiency among the receiving customers. Each time a delivery or pickup is made through the technology, the route details will be saved to the system for future use (knowledge share). As shippers and receivers are added to the database, delivery and pickup points that are negotiated with the broker or carrier will be communicated through this technology platform so as to communicate such delivery and pickup locations with the driver that is servicing that account at that time. Any changes to a contract with a shipper or receiver will automatically be uploaded into the system to show any changes for future service requirements. The company, through knowledge share, would educate employees as their own drivers to ensure a critical overlap of knowledge base for customer satisfaction and service, including efficiency of delivery and improvement in revenue.

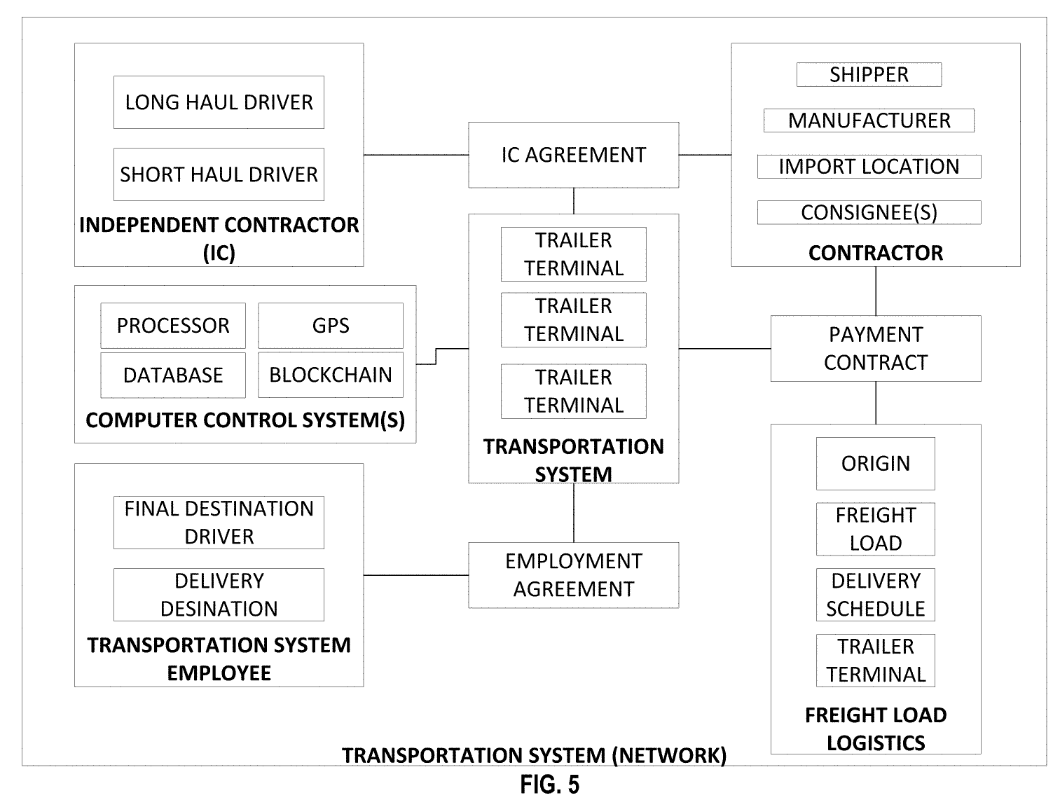

FIG. 5 is a pictorial representation of a transportation network and personnel contract fulfillment system for continuous movement of cargo in accordance with an illustrative aspect of the present disclosure. Elements of the transportation system (network) are disclosed at least by the illustration in FIG. 5. For example, the transportation system can include an independent contractor (“IC”) system for monitoring, tracking, and working with independent contractor drivers operating both long and short haul routes. Independent contractor drivers contract with the transportation system via a legal instrument, such as an independent contractor agreement. Additionally, the transportation system can include a transportation system employee system to monitor, track and otherwise work with employee drivers of the transportation system operating as a final destination driver and other delivery destination as set forth herein. Employee drivers contract with the transportation system via a legal instrument, such as an employee agreement. As discussed herein, the transportation system can include any number of trailer terminals spaced apart in a geographical region where freight is moved. The transportation system can be controlled in whole or in part, both manually and/or electronically, using one or more computer control systems with a processor and database. The control system receives, stores and sends GPS data and manages smart contracts of the transportation system using blockchain technology. All information from contract execution to delivery will be managed on the blockchain. The reason we are choosing to facilitate all information on the blockchain is due to the security necessary to continually move the information from shipper to receiver and to establish a link between multiple players involved in the movement of goods. Blockchain technology can never be duplicated, recreated or deleted and carries with it a superior security that will always outlive any trustless practices. The computer control system(s) can also be used to issue, store, execute, and send payment contracts to drivers based on the type of contractor information (e.g., shipper, manufacturer, import location, consignee(s)). Other data, amongst the non-limiting capabilities of system, can include use of the computer control system to receive, process, manage, store and issue cargo load logistics associate with any cargo load, such as parameters/details relating to origin, cargo load type, delivery schedule, trailer terminal details, and other cargo-related information.

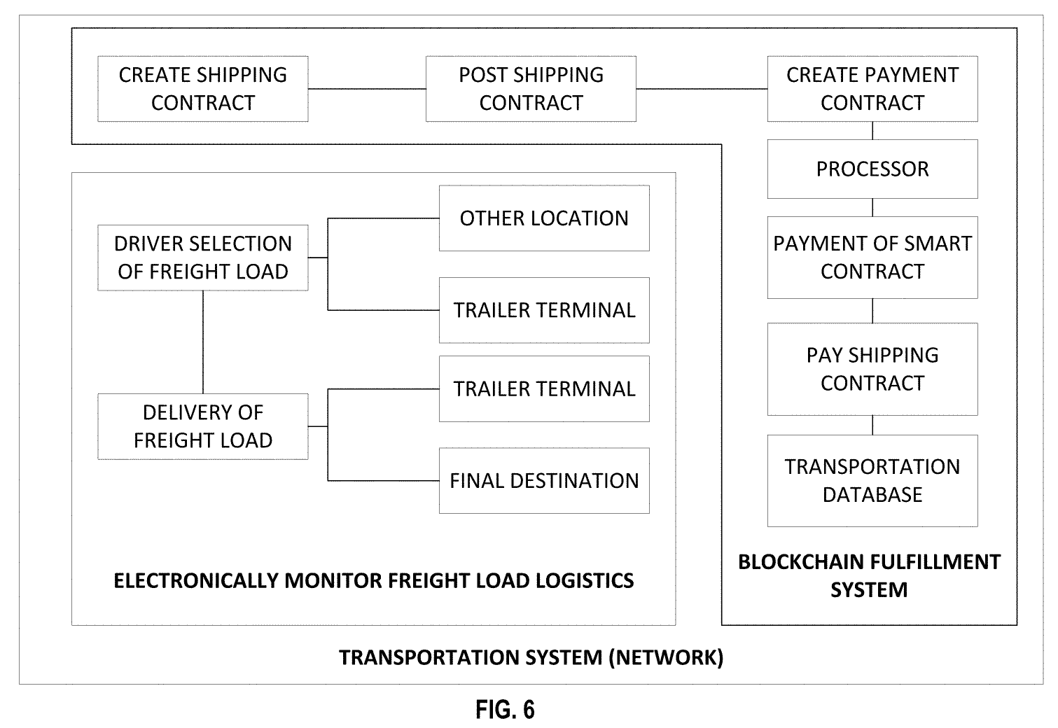

FIG. 6 is a pictorial representation of another transportation network and payment fulfillment system diagram system for continuous movement of cargo in accordance with an illustrative aspect of the present disclosure. The transportation system (network) provides for immediate payment to drivers by electronically monitoring cargo load logistics and leveraging blockchain fulfillment system Made operable using the computer control system(s). Logistics of each cargo load can be acquired using the computer control system(s). Some logistics are traceable, trackable and monitorable using GPS and other sensors providing data to the computer control system(s). Some parameters to monitored include, for example, driver selection of cargo loads to/from trailer terminals and/or other locations and/or delivery cargo load to/from trailer terminals and to final delivery destinations. Delivery of the cargo load is only one aspect of the transportation system/network. Payment of the delivery contract, preferably immediate upon delivery of the cargo load, can be executed using blockchain technology, such as a blockchain payment fulfillment system associated with the computer control system(s). The blockchain payment fulfillment system includes receiving, tracking, processing, storing, executing, and issuing/handling payment aspects of the transportation system of the present disclosure. These can include, for example, creating shipping contracts, posting shipping contracts, creating payment contracts, payment of smart contracts and shipping contracts using a processor and transportation database.

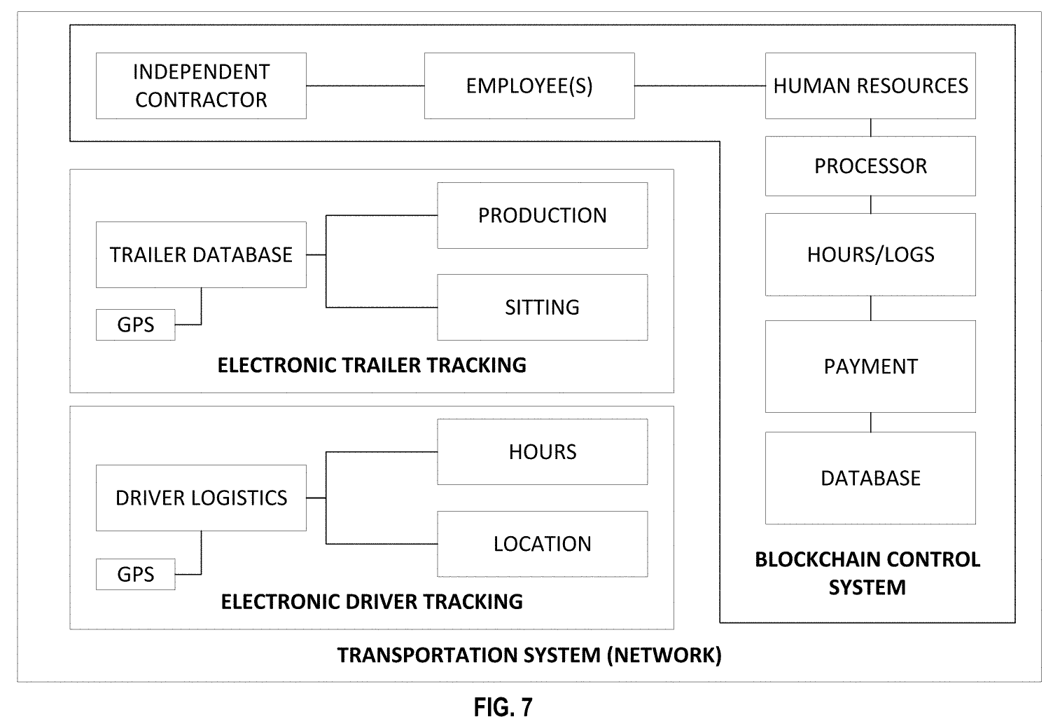

FIG. 7 is a pictorial representation of a transportation network and logistics control system for continuous movement of cargo in accordance with another illustrative aspect of the present disclosure. The transportation system (network) can include an electronic trailer tracking system, electronic driver tracking system and a blockchain control system operable using a computer control system(s) of the transportation system. The electronic trailer tracking system can be operated manually and/or electronically using computer control system(s) of the present disclosure. The electronic trailer tracking system includes a trailer database for monitoring, tracking and storing the status of each trailer (e.g., trailer(s) in production and/or trailer(s) sitting) using one or more offboard or onboard sensors under operable control by the computer control system(s). The one or more sensors can be sensors configured to collected GPS data from each of the trailers for maintaining status of each trailer in the trailer database. Similarly, the electronic driver tracking system can be operated manually and/or electronically using computer control system(s) of the present disclosure. The electronic driver tracking system includes a driver logistics system for monitoring, tracking and storing data relating to the status of each driver (e.g., long haul, short haul and final destination driver) by tracking hours, location and other driver-related information using one or more onboard, offboard and/or wearable sensors under operable control of a computer control system(s). The one or more sensors can be sensors configured to collected GPS data from each of the drivers for maintaining status of each driver within the driver logistics system and database. All functions and elements of the transportation system can be handled manually. In a preferred aspect, most functions of the transportation system are managed, monitored, executed, and recorded using a blockchain environment. In a preferred aspect, a hyperledger system, such as those offered/created by IBM, can be used. The blockchain control system, made operable using computer control system(s) of the present disclosure, can include performing functions, such as managing, monitoring, recording records, contracts and logistics relating to and issuing payment to independent contractors upon fulfillment of a shipping contract. Similarly, the blockchain control system, made operable using computer control system(s) of the present disclosure, can include performing functions, such as managing, monitoring, recording records and logistics relating to and issuing payment to employee(s) of the transportation system. In another aspect, the blockchain control system, made operable using computer control system(s) of the present disclosure, can include performing functions, such as managing, monitoring, recording records, hours and personnel information relating to independent contractors, employees and others associated with the transportation network. One or more processors of the computer control system(s) can be configured to control, record, and oversee one or more processes/functions of the blockchain control system. Functions and processes can include, for example, managing and recording hours of each driver in the transportation system, executing payment upon completion of a delivery contract, and recording resulting data or other data acquired by the transportation system in a database.

### Example: Transportation System (Network)

The following is provided simply as one example of many, and is not intended to limit the disclosure.

### Shipper/Consignee

The transportation system of the present disclosure eliminates redundant costs and provides a cheaper solution to the shipper while improving time in transit for the continuous movement of cargo across the United States through the interconnected web of secure trailer terminal sites and providing a platform for final destination delivery to the receiving customer.

### Driver Network

The transportation system of the present disclosure can include a network of trailer terminal locations setup across the US and be within 350 miles from each other so as to produce no longer than a 11-hour run to and from each site. This will allow for one day runs based on a to and from hours of service calculation that do not exceed 11 hour days behind the wheel (e.g., using hour/day calculations based off of 65 mph roadways). Amongst other benefits, the transportation system can improve driver flexibility on long/short haul runs to allow for selective route patterns conducive to driver knowledge and preference and to also allow a driver to run shorter patterns so as to be closer to origin/home at all times if preferred, so they have the option to be back home as dictated by their travel selections. Payment system(s) of the transportation system are setup to ensure prompt and immediate payment to driver for each individual run between trailer terminal sites. This can eliminate waiting for payment or need to engage a 3rd party broker or factoring company.

### Increased Efficiency

Trailers will be continuously moving through the network via long/short haul independent contractors. These independent contractors, in a preferred aspect, will not perform final mile delivery to a final delivery destination so as to keep their limited final mile knowledge base on the highway/interstate system where trailer terminal sites will be strategically located within immediate access to the interstate system. Employees of the transportation system can be tasked with delivering final leg (within 250 miles give or take based on region). Their local knowledge base will help improve efficiency among the receiving customers. The transportation system can provide an educational component provided, for example, via a computer, classes, online instruction and other tutorials for training drivers to ensure a critical overlap of knowledge base for customer satisfaction and service.

### Step 1

Load is originated via shipper/manufacturer or import location for all inbound international cargo. Pre-negotiated contracts based on origin of load and delivery location determine payment from shipper at that time prior to load entering the transportation system. Once a cargo load is originated and entered into the system, an origin trailer terminal and transportation system employee from the terminal provide pickup from customer, import or other location for bringing the cargo load back to the trailer terminal for entering the trailer and its accompanying details into the transportation network.

### Step 2

Once load has entered the secure transportation system, the independent contractors on the platform will have the ability to choose, in order of preference, for example, top 5 locations for their next run. Programs, algorithms or decision matrices can be used, manually and/or electronically with computer assistance, to address shortfalls on low demand runs. After a travel plan is awarded, the driver picks up the cargo load from the trailer terminal and checks out with security. In one aspect, the driver can sign an agreement or contract turning over liability of load to the driver from the origin terminal to a destination terminal. The driver can then take the awarded cargo load to the next trailer terminal. Once checked in, the driver can have first option on that load to move to the next site as long as hours of service will allow for safe and timely passage to the next site. If the driver is out of hours or opts to go back into the transportation system to choose another destination, the driver can do so at this time after disconnecting and dropping trailered cargo load at predetermined staging location within the secure trailer terminal. The function of the transportation system repeats itself once the driver returns from fulfilling the shipping contract.

### Step 3

Final mile delivery or final destination delivery can take place once a trailer is securely staged at final trailer terminal. An employee of the transportation system can provide final destination delivery to a customer location based on pre-negotiated contract terms with the receiver of the cargo load. Once delivery is executed and consignee has signed off on the load, the transportation system can no longer be held liable for cargo load. At this point one of two things can happen, the transportation system employee can wait for the cargo load to be unloaded at the consignee's location and then return emptied trailer to a trailer terminal for re-use, or if consignee is also a shipping customer of the transportation system, the trailer can be left at consignee's site and be reused for a new originating load by the shipper.

### Technology Databases/Systems

### Database 1

Trailer Database: A trailer database can oversee where all trailers are at, at any given time (e.g., production and sitting). A combination of GPS technology and a computer processor/system integrates with transportation system shippers so as to register all empty and loaded loads by the shipper and or consignees to ensure no missed/not unloaded or unshipped loads. The database and related functions can also be backed up using manual records, electronic sensors, or by a transportation system employee on deliveries and pickups.

### Database 2

A driver log hours/trailer tracking database can be configured to store, process and make decisions within the transportation system regarding driver logistics. The database can track wheels in motion hours so as to have an open book in regard to driver log hours and also give 24/7 visibility to the trailer tracking system.

### Database 3

Independent Contractor/Employee database can be configured to log all independent contractors and employees into a payment and timecard system.

### Payment Systems

Payments to drivers can be made using current technology, but preferably using blockchain payment processing. Payment methods, can include, for example:

1) ACH for independent contractors
2) Shipper payment platform utilizing ACH
3) Block chain technology, for smart contracts, payment systems, shipment tracking and visibility, ledgers of information as needed

### Trailer Terminal Sites

Trailer terminals can be a 24/7, 365 day a year operation. The trailer terminal can be secure and maintained 24/7. Each site can have required paving for product demand. Each site can also include local maintenance/mechanic facility for trailer repairs and maintenance of grounds. All sites are preferably within visibility of interstate system and can have interstate signage directing traffic to each trailer terminal of the transportation system. Support services can be provided at each trailer terminal site, such as, food, fuel, trucking services, wash tunnels, and hotels. Types and capacity for other services can change as markets dictate.

### Transportation System

The transportation system can transition from current real-world application as shown and discussed above and transition to an autonomous, seamless and efficient environment as the market and technology grows in the future. The transportation system can be readily adaptable to new environments and can continue to grow with the acquisition of new land sites to construct trailer terminals thereby changing the final destination delivery of cargo loads. The transportation system provides for the flexibility and future demands in the logistics industry. Payment systems can be used with the transportation system, such as, blockchain technology to provide smart contract solutions that can ensure ease of use and continued flexibility for all independent contractors, shippers and consignees as well as employees of the transportation system.

### Utilization of Blockchain Technology

Blockchain technology can play an integral role in the transportation and logistics system of the present disclosure. The demand for private, secure, and immediate information will be the largest driver to blockchain technologies and their use within the transportation industry. The transportation system utilizes blockchain technology to provide tracking and visibility of shipments for shippers, to provide a support system to manage traffic and information, to provide a secure money management system to handle everything from accounts payables and receivables to payroll via smart contracts. The transportation system can incorporate the blockchain technology to provide for the regulatory agencies a clear and unprecedented log of real time information to ensure internal accuracies of the management of its workforce so that adherence to safety standards can be controlled in the management and movement of cargo loads globally.

What is claimed is:

1. A method for continuous movement of cargo through trailer terminal sites and final delivery to a destination, comprising:
providing a service transportation network operating a network of trailer terminals spaced apart geographically for receiving, staging and/or delivering a cargo load transported by a driver, wherein the driver operating as an independent contractor enters into an agreement with the service transportation network as a short haul driver for each cargo load, or the driver is a final destination driver and an employee of the service transportation network for each cargo load;
creating a payment contract for the cargo load between a shipper, manufacturer, import location, or consignees and the service transportation network based at least on an origin of the cargo load and a delivery location of the cargo load;
selecting by the independent contractor driver a cargo load from a number of cargo loads at one of the trailer terminals from one of the network of trailer terminals, wherein the cargo load has a delivery schedule with one or more legs between an origination trailer terminal and a destination trailer terminal;
receiving the cargo load at a final destination trailer terminal;
delivering the cargo load to a final delivery destination by the final destination driver;
monitoring location of each cargo load electronically and updating a database associated with the service transportation network; and
executing payment to the short haul driver upon completion of each leg by issuing payment using a payment system.

2. The method of claim 1, wherein the trailer terminals are spaced apart geographically at least no further than a driving distance permitted under the Department of Transportation hours of service rules for over-the-road drivers.

3. The method of claim 1, further comprising:
creating the payment contract before entering the cargo load into the service transportation network.

4. The method of claim 1, further comprising:
arranging for movement of the cargo load from the shipper, manufacturer or import location to the originating trailer terminal by the service transportation network.

5. The method of claim 1, further comprising:
transporting one of the one or more legs of the selected cargo load by the independent contractor driver from the origination trailer terminal to the destination trailer terminal.

6. The method of claim 5, further comprising:
transporting another one of the one or more legs of the selected cargo load by the independent contractor driver from the origination trailer terminal to the final destination trailer terminal; or
transporting one of the one or more legs of another selected cargo load by the independent contractor driver from one trailer terminal to the another trailer terminal in closer geographical proximity to the final delivery destination.

7. The method of claim 1, further comprising:
unloading the cargo load from a trailer at the final destination and leaving the trailer at the final destination if a receiver at the final destination is a shipper affiliated with the service transportation network, wherein the trailer is loaded with a new originating cargo load.

8. The method of claim 1, further comprising:
tracking status of each trailer logged into the database of the service transportation network, wherein the status includes loading, unloading, sitting, or in-transit.

9. The method of claim 1, further comprising:
tracking wheels-in-motion to create a driver log of hours for each driver, driver availability, and location.

10. The method of claim 1, further comprising:
logging each independent contractor driver into the database to coordinate payment using the payment system of the service transportation network.

11. The method of claim 1, further comprising:
logging final leg driver hours into the database to coordinate payment using a timecard system of the service transportation network.

12. The method of claim 1, wherein the network of trailer terminals include one or more support services for transporting the cargo load and are located within proximity of one or more interstate highways.

13. The method of claim 1, further comprising:
executing one or more smart contracts between the service transportation network and the independent contractor driver, a shipper, manufacturer, import location, consignees, or employee of the service transportation network.

14. The method of claim 13, further comprising:
executing the one or more smart contracts and payment of the short haul drivers and employee of the service transportation network with a blockchain system.
